(19) United States
(12) Patent Application Publication
(10) Pub. No.: US 2026/0094092 A1
(43) Pub. Date: Apr. 2, 2026

(54) SYSTEM FOR AUTOMATING BUSINESS PROCESS WORKFLOWS

(71) Applicant: DevRev, Inc., Palo Alto, CA (US)

(72) Inventors: Pratham Gupta, Ahmedabad (IN); Aman Mahajan, Ahmedabad (IN); Prakhar Agarwal, Bengaluru (IN); Vikas Sheoran, Bengaluru (IN); Hriday Gajulapalli, Bengaluru (IN)

(73) Assignee: DevRev, Inc., Palo Alto, CA (US)

(21) Appl. No.: 19/094,780

(22) Filed: Mar. 28, 2025

(30) Foreign Application Priority Data
Sep. 30, 2024 (IN) 202441073846

(51) Int. Cl. G06Q 10/0631; G06F 8/35; G06Q 10/10

(52) U.S. Cl. CPC G06Q 10/06316; G06F 8/35; G06Q 10/10

(57) ABSTRACT

The invention provides a system for automating business process workflows. The system includes a user interface that is configured to receive natural language inputs corresponding to a business process from a user. The system further includes a large language model (LLM) based module that is configured to generate a generic automation structure for the business process in response to the received natural language inputs. The automation structure comprises a plurality of atomic operations. The system further includes an automation generation module that is configured to identify events and actions corresponding to each atomic operation of the automation structure using a pre-determined catalogue of available events and actions and to generate a deterministic workflow using the identified events and actions.

### RELATED APPLICATION DATA

This application claims priority to, and the benefit of, Indian Patent Application No. 202441073846 filed on Sep. 30, 2024. The entire disclosure of the above application is expressly incorporated by reference herein.

### FIELD OF INVENTION

Embodiments of the present disclosure relates to the field of business process automation, and more particularly to, a system and method for automating business process workflow.

### BACKGROUND

As businesses increasingly adopt digital tools and platforms, automating repetitive tasks and complex workflows has become essential for efficiency and productivity. Traditional methods of workflow automation, such as manual configuration of scripts or business logic, often require specialized knowledge of coding, domain expertise, and significant time investment. This results in challenges for organizations seeking to quickly adapt to changing business needs or integrate automation across diverse platforms.

Recent advancements in artificial intelligence (AI) and natural language processing (NLP) offer new possibilities for simplifying the automation process. Large language models (LLMs) can interpret human language with a high degree of accuracy, allowing users to describe business processes in natural language. However, translating these high-level descriptions into executable automation workflows remains a challenge due to the complexity and diversity of actions, events, and conditional checks involved.

The landscape of automation tools either requires significant manual intervention or is highly platform-specific, making it difficult to migrate automations across different platforms. Additionally, while some tools offer drag-and-drop interfaces, they do not always scale well with complex workflows or allow seamless integration with various business applications.

There is a need for a system that can dynamically create and customize automation workflows using natural language inputs, allowing users to conveniently define business processes.

### BRIEF DESCRIPTION

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for automating business process workflows is provided. The system includes a user interface that is configured to receive natural language inputs corresponding to a business process from a user. The system further includes a large language model (LLM) based module that is configured to generate a generic automation structure for the business process in response to the received natural language inputs. The automation structure comprises a plurality of atomic operations. The system further includes an automation generation module that is configured to identify events and actions corresponding to each atomic operation of the automation structure using a pre-determined catalogue of available events and actions and to generate a deterministic workflow using the identified events and actions.

According to another example embodiment, a system for automating business process workflows is provided. The system includes a memory storing one or more processor-executable routines and a processor communicatively coupled to the memory. The processor is configured to execute one or more processor-executable routines to receive natural language inputs corresponding to a business process. The processor is further configured to generate a generic automation structure for a business process in response to the received natural language inputs. The automation structure comprises a plurality of atomic operations. The processor is further configured to access a pre-determined catalogue of available events and identify events and/or actions corresponding to each atomic operation of the automation structure to generate a deterministic workflow corresponding to the business process. The processor is further configured to implement the deterministic workflow on a user platform.

According to another example embodiment, a method for automating business process workflows is provided. The method includes receiving natural language inputs for a business process. The method further includes processing the inputs using large language model (LLM) to generate a generic automation structure. The automation structure comprises a plurality of atomic operations corresponding to steps in the business process. The method further includes determining corresponding events and actions for each atomic operation via a pre-determined catalogue of available events and actions. The method further includes generating a deterministic workflow by integrating the determined events and actions into the generic automation structure. The method further includes providing the deterministic workflow for user review and/or modification. The method further includes implementing the deterministic workflow to achieve a desired output.

### BRIEF DESCRIPTION OF THE DRAWINGS

The disclosure will be described and explained with additional specificity and detail with the accompanying figures in which:

FIG. 1 is a system for automating business process workflows in accordance with the embodiments of the invention;

FIG. 2 is a representation illustrating the workflow of a system for automating business process workflows;

FIG. 3 is a flowchart illustrating the process of automating business process workflows; and

FIG. 4 is a block diagram of an embodiment of a computing device in which the system for automating business process workflows, described herein, are implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled. ” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture for an automation system envisaged to streamline creation and management of business process workflows.

Embodiments of the invention provide an automation system for business process workflows that offers comprehensive, dynamic, and end-to-end process automation capabilities. The example embodiments described below address significant challenges in conventional workflow automation, where users often face difficulties translating business processes into executable workflows and managing them across different platforms. The Artificial Intelligence (AI)-driven system integrates natural language processing and automation generation provides real-time contextual understanding to transform user-described business processes into structured automation workflows. By leveraging advanced machine learning models, the system identifies, configures, and executes appropriate actions and events, while also allowing for user review and adjustments at each step. This seamless integration of automation enhances operational efficiency, adaptability, and user control, thereby optimizing business processes and ensuring precise workflow execution.

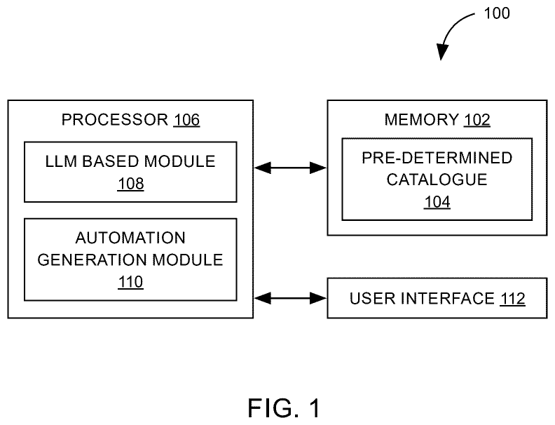

FIG. 1 illustrates a system 100 for automating business process workflows in accordance with the embodiments of the invention. The system 100 for automating business process workflow includes a memory 102, and a processor 106 communicatively coupled to the memory 102. The memory 102 is configured to store one or more processor-executable routines. The processor 106 is configured to execute the one or more processor-executable routines to process natural language inputs corresponding to a business process into deterministic workflow. The system 100 further includes a user interface 112 that is configured to receive the natural language inputs from a user. Moreover, the processor 106 includes a large language model (LLM) based module 108 and an automation generation module 110 to generate the automation structure.

The user interface 112 is configured to facilitate interaction between the user and the system 100. The user interface 112 is further configured to facilitate review of the generated automation structure by the user, and make modifications as necessary.

In this embodiment, the processor 106 is configured to receive natural language inputs from the user via the user interface 112. These inputs correspond to business processes provided by the user. In one embodiment, the natural language includes English language. However, the system 100 may be configured for use for other languages such as Spanish, French and so forth. The LLM based module 108 is configured to process these natural language inputs to generate a generic automation structure for the business process in response to the received natural language inputs. The generic automation structure includes a plurality of atomic operations corresponding to the steps of the business process.

The automation generation module 110 is configured to identify events and actions corresponding to each atomic operation of the automation structure using a pre-determined catalogue 104 of available events and actions. In one embodiment, the automation generation module 110 is configured to identify events and actions corresponding to each atomic operation of the automation structure using a semantic search, a syntactic search, or combinations thereof. However, other techniques may be envisaged. The pre-determined catalogue 104 includes a variety of pre-defined events, actions, and conditions. In certain embodiments, the pre-determined catalogue 104 is stored in the memory 102 and may be periodically updated with new events and actions.

The automation generation module 110 is further configured to stitch together one or more of the events, actions and conditional checks to generate a deterministic workflow

The deterministic workflow may be implemented for a user's platform, to execute the workflow to automate the desired business process. In one example, the automation generation module 110 is further configured to receive inputs for each of the plurality of atomic operations and to process the received inputs using the respective atomic operation and to generate a corresponding output. Moreover, the automation generation module 110 is configured to generate input for one or more subsequent atomic operations based upon the generated output of the previous atomic operations.

In one embodiment, the inputs and/or output of each of the plurality of atomic operations are presented to the user via the user interface 112 for review. Moreover, the system 100 is configured to receive user inputs on the presented inputs and outputs and adjust and/or modify one or more of the inputs and the automation structure based upon the user inputs.

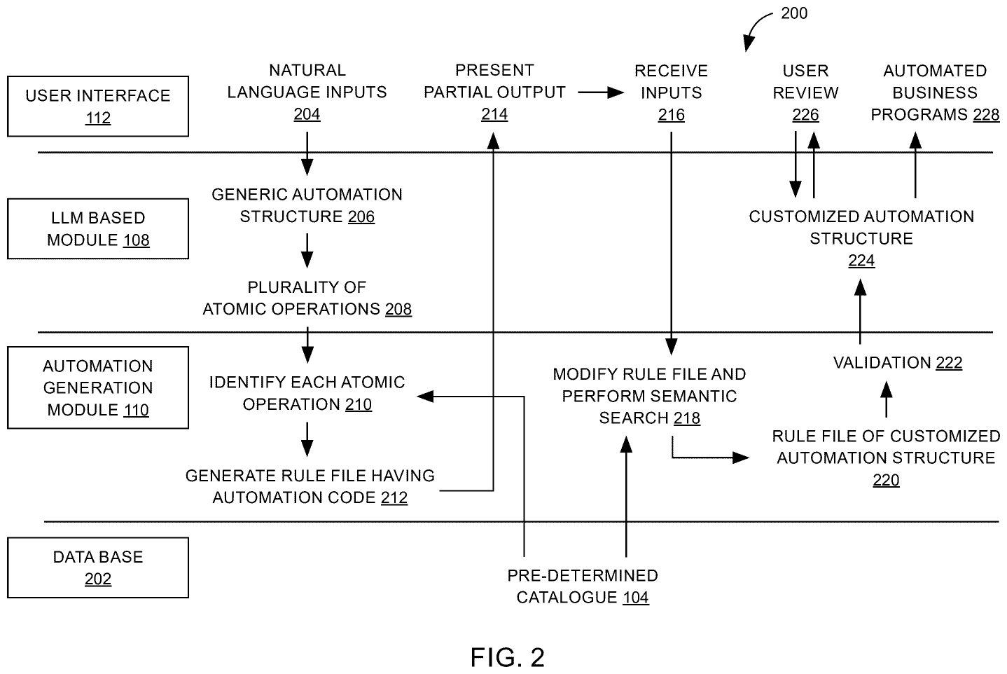

In further embodiments, the system 100 is configured to facilitate the migration of a plurality of automated business programs across different platforms using natural language inputs, ensuring cross-platform compatibility and scalability. Additionally, the system 100 may be deployed on a cloud-based platform, allowing for easy access and management from various user environments. The detailed workflow of the system 100 for automating the business process workflow is further described with reference to FIG. 2.

FIG. 2. illustrates a workflow 200 of the system 100 of FIG. 1. for automating a business process workflow according to embodiments of the invention. As described above, the system 100 includes the user interface 112, the LLM based module 108, the automation generation module 110 and a database 202. The system 100 is configured to receive natural language inputs 204 corresponding to the business process from the user via the user interface 112. The natural language processed by the system 100 is typically English, although the system 100 can be configured to support other languages.

The LLM based module 108 is configured to process the natural language inputs 204 to generate a generic automation structure 206, that is defined using a plurality of atomic operations 208. Each atomic operation represents a distinct step in the automation process, forming the backbone of the automation structure.

Each atomic operation is processed by the automation generation module 210, to identify the corresponding events and actions using the pre-determined catalogue 104 of available actions and events. The automation generation module 110 is configured to receive inputs for each of the plurality of atomic operations 210, process the inputs using the respective atomic operation, and generate a corresponding output. The system 100 can then generate input for subsequent atomic operations based on the output of previous operations, ensuring continuity and logical flow in the business process.

The automation generation module 110 is further configured to employ techniques such as semantic search, syntactic search, and using reranking models along with LLMs to match each atomic operation with relevant actions from the pre-determined catalogue 104. Furthermore, the automation generation module 110 is configured to stitch together one or more events, actions, and conditional checks to form a deterministic workflow.

In this embodiment, the automation generation module 110 is further configured to generate a rule file/automation code 212, containing automation code that corresponds to the identified events and actions. The system 100 is configured to communicate with one or more databases 202 to generate the automation code by accessing relevant data from external sources. The system 100 is configured to present the rule file/automation code 212 in the form of the partial output 214 to the user for review. The partial output 214 could be in the form of graphical representation or the code itself. Other ways of representing the partial output 214 may be envisaged. The rule file/automation code 212 displays the inputs and outputs of each atomic operation. The user can provide feedback, suggest changes, or modify the inputs and outputs using the user interface 112. Based on the user inputs 216, the system 100 is configured to modify the rule file/automation code 212 accordingly and adjust the automation structure by refining the operations through additional semantic/syntactic searches 218.

The system 100 is configured to use the pre-determined catalogue 104 of available events and actions to refine the rule file/automation code 212 and generate a modified rule file/automation code having automation code for deterministic workflow 220. In some embodiments, the modified rule file/automation code 220 is validated using a validation process 222 to ensure that the automation structure and the automation code are accurate and aligned with the business process. Post the validation process 222, the deterministic workflow 224 is generated and executed by the system 100, The deterministic workflow 224 implements the automated business program 228 on the user's platform after the review of user (226).

In operation, the system 100 is configured to update the pre-determined catalogue 104 of events and actions based on user feedback and system trends, ensuring that the pre-determined catalogue 104 is current and relevant.

Additionally, the system 100 is configured to facilitate migration of automated business programs 228 across different platforms using natural language, making it adaptable and flexible for various business environments. The workflow 200 of the system 100 is designed to allow user intervention at multiple stages, ensuring that the automation process is aligned with the user's business goals.

Moreover, the system 100 can be implemented on a cloud-based platform, allowing it to be scalable, accessible, and capable of serving multiple users or organizations without the need for local hardware.

As will be appreciated by one skilled in the art, the end-to-end process described above allows users to transform natural language instructions into fully automated business programs 228, with opportunities to review and modify outputs, ensuring a high degree of customization and accuracy in the final automation structure.

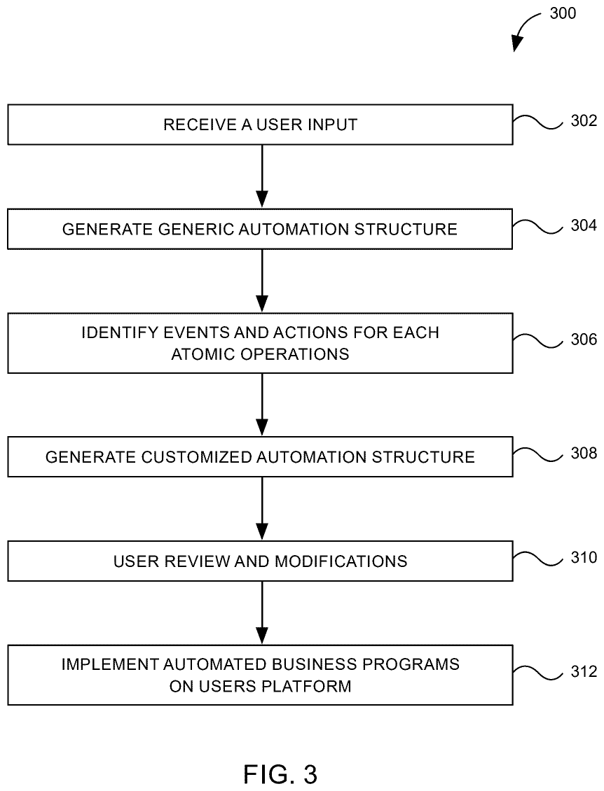

FIG. 3 is a flowchart 300 illustrating the process of automating business process workflows in the system 100 of FIG. 1. At block 302, the system receives a natural language inputs provided by the user via the user interface. The natural language inputs correspond to a business process. The inputs, typically provided in English, describe the steps, conditions, and overall goals of the business process that the user wants to automate.

The system processes the received natural language inputs to determine key tasks and steps for the automation workflow. Once the system processes the natural language inputs, the LLM based module interprets the user's instructions and generates a generic automation structure (block 304). The generic automation structure represents the business process at a high level, and includes a plurality of steps generally referred herein as “atomic operations”. Each atomic operation corresponds to an individual step or task in the business process.

At block 306, the automation generation module of the system identifies specific events and actions associated with each atomic operation within the generic automation structure. The module may utilize a pre-determined catalogue of available events and actions to identify the specific events and actions and conditional checks. The system uses advanced techniques like semantic search, syntactic search, and reranking models along with LLMs to match each atomic operation with relevant events and actions from the pre-determined catalogue.

Once the events and actions are identified, the system generates a deterministic workflow by integrating these events and actions into the generic automation structure (block 308). The system ensures that the atomic operations are stitched together using appropriate conditional checks and logical flow, forming a comprehensive automation workflow. The automation generation module generates the rule file/automation code that contains the automation code, reflecting the specific requirements and logic of the user's business process.

At block 310, the system presents the graphical representation of the rule file/automation code having deterministic workflow to the user for review. The system displays the inputs and outputs for each atomic operation, allowing the user to inspect and validate the automation rule file/automation code. The user may provide feedback or make modifications to ensure the automation structure aligns with the business requirements. The system receives these inputs and updates the rule file/automation code accordingly, making necessary adjustments to the automation structure. This interactive review process allows for fine-tuning of the workflow before implementation.

At block 312, the automated business program is implemented on the user's desired platform. The system deploys the rule file/automation code and executes the automation workflow, enabling the automation of the business process. The automation program is designed to work seamlessly across a variety of platforms, ensuring flexibility in deployment. The system is configured to support periodic updates and modifications to the automation structure as the business process evolves. This comprehensive process ensures effective transformation of natural language inputs into a fully automated business process.

In further embodiments of the disclosure, example use cases are presented.

In one embodiment of the disclosure, the system automates the process of managing and nurturing leads for a sales team using natural language instructions. The workflow begins with a user input in English language, such as: “When a new lead is added to the CRM, check if the lead is from a high-priority industry. If it is, assign the lead to a senior sales representative. If not, send a welcome email and schedule a follow-up call in three days.”

The system processes this input and, using the LLM, generates a generic automation structure for the lead management process. This structure includes a plurality of atomic operations, which are divided into two categories such as trigger-based atomic operations and conditional atomic operations. For instance, the first atomic operation in this example is a trigger-based atomic operation, which is activated when a new lead is added to the CRM. The second atomic operation is a conditional atomic operation, in which the system checks whether the lead belongs to a high-priority industry.

The system then identifies events and actions for each atomic operation, using a pre-determined catalogue of available events and actions. In this example, the system identifies the event of adding a lead as a first atomic operation and then determines the action of assigning the lead to a senior sales representative if the lead is from a high-priority industry. If the lead is not from a high-priority industry, the system automatically generates a second action that includes sending a welcome email to the lead and scheduling a follow-up call for three days later.

Next, the system proceeds to generate a deterministic workflow by integrating the identified events and actions into the generic automation structure, aligning with the user's specific instructions. The system allows for user review and modification, where the automation structure, including a partial rule file/automation code displaying the inputs and outputs of each atomic operation, is presented to the user. The partial rule file/automation code may be in the form of a graphical representation or code itself. The user can review and modify the proposed automation workflow, ensuring it aligns with their intent and business requirements.

Once the user has reviewed and validated the automation structure, the system proceeds to implement the automated business program on the user's platform. This involves executing various operations, such as assigning high priority leads to senior sales representatives, sending welcome emails to non-priority leads, and scheduling follow-up calls, all based on the specified conditions and actions.

By automating these tasks, the system enhances efficiency and consistency in lead management, ensuring that high-priority leads are handled by experienced sales representatives, while initial communications and follow-up scheduling are streamlined for all leads. This process improves overall lead nurturing and conversion rates, ensuring the sales team can focus on critical tasks while routine activities are handled automatically by the system.

In another example, the system automates a dynamic pricing strategy for an e-commerce platform by processing complex natural language inputs. The user provides the following natural language input: “Monitor competitor prices for similar products and adjust our prices to be 5% lower if our inventory levels are high. If inventory levels are low, increase prices by 10%. Additionally, if customer demand spikes for a particular product, increase the price by 15% for the next 24 hours. Send a daily report to the pricing manager with the changes made.” Using the LLM, the system generates a generic automation structure consisting of multiple atomic operations, each representing a specific action, condition, or event. The first atomic operation is a trigger based on monitoring competitor prices for similar products. This involves continuously tracking competitor pricing data using an API or a webhook (e.g., a Watcher webhook) that enables real-time price monitoring.

Once competitor prices are monitored, the system checks two conditions: inventory levels and customer demand. If the inventory levels are high, the system applies the first conditional atomic operation to lower the product prices by 5% compared to competitors. This price adjustment is executed as an action by updating the prices on the e-commerce platform in real time. If the system detects that inventory levels are low, a second conditional atomic operation triggers, instructing the system to increase prices by 10%.

Additionally, the system is configured to monitor customer demand as another conditional atomic operation. If a spike in demand is detected for a particular product, the system performs an action to increase the price by 15% for the next 24 hours, thus responding dynamically to market conditions. This dynamic price adjustment is based on real-time customer behaviour analysis, further refining the automation structure.

Once the necessary price adjustments are made, the system proceeds to the next step of generating a deterministic workflow, integrating the identified events, conditions, and actions into the pricing strategy. This structure is then presented to the user for review and modification. A rule file/automation code displaying the inputs and outputs of each atomic operation is generated, allowing the user to validate the automation workflow. The user can review the suggested price adjustments, demand spikes, and inventory status, and modify the strategy based on the business objectives.

After the user review, the system proceeds to implement the automated business program by updating product prices in real time on the e-commerce platform. The system ensures that price changes are applied based on the defined conditions, including competitor prices, inventory levels, and customer demand. As part of the final step, the system also generates and sends a daily report to the pricing manager, detailing all price adjustments made during the day. This ensures that the pricing manager remains informed about the changes in real-time and can adjust future strategies as needed.

This automated pricing process addresses multiple challenges, such as continuously monitoring competitor prices, adjusting prices dynamically based on inventory and demand, and generating accurate and timely reports. By automating these tasks, the system allows the platform to maintain a competitive edge in pricing strategies while reducing manual effort, improving efficiency, and ensuring real-time responsiveness to market conditions.

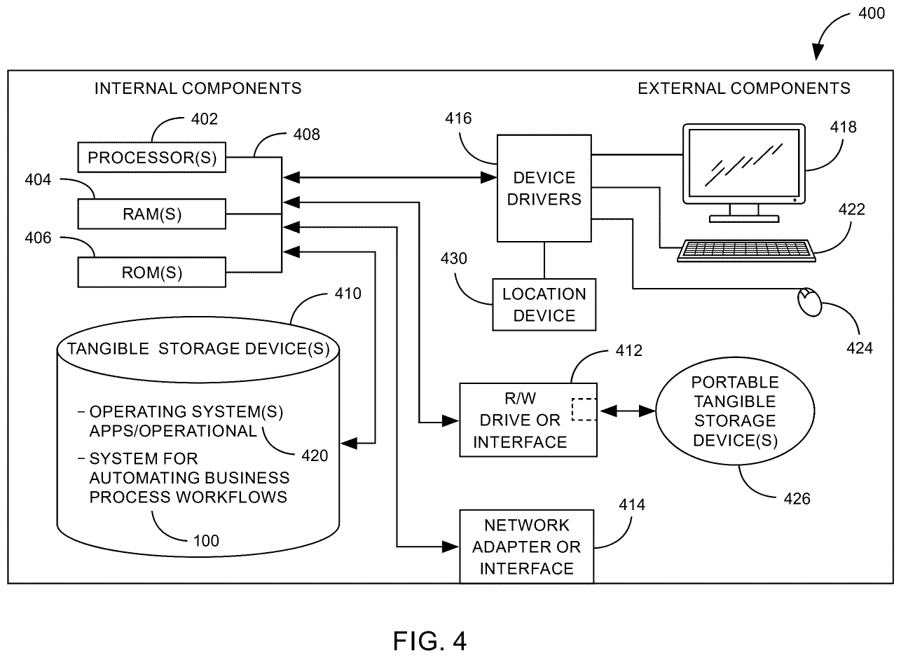

The modules of the system 100 for automating the business process workflow, described herein, are implemented in computing devices to facilitate user assistance and task execution. One example of a computing device 400 is described below in FIG. 4. The computing device 400 includes one or more processor(s) 402, one or more computer-readable RAMs 404, and one or more computer-readable ROMs 406 on one or more buses 408. Further, the computing device 400 includes a tangible storage device 410 that may be used to execute operating systems 420 and the system 100 for automating the business process workflow. The various modules of the system 100 for automating the business process workflow may be stored in the tangible storage device 410. Both, the operating systems 420 and the system 100 for automating the business process workflow are executed by one or more processor(s) 402 via one or more respective RAMs 404 (which typically include cache memory). The execution of the operating systems 420 and/or the system 100 for automating the business process workflow by the one or more processor(s) 402, configures the one or more processor(s) 402 as a special purpose processor configured to carry out the functionalities of the operation systems 420 and/or the system 100 for automating the business process workflow as described above.

Examples of tangible storage devices 410 include semiconductor storage devices such as ROM, EPROM, flash memory, or any other computer-readable tangible storage device that may store a computer program and digital information.

The computing device 400 also includes an R/W drive or interface 414 to read from and write to one or more portable computer-readable tangible storage devices 428 such as a CD-ROM, DVD, memory stick, or semiconductor storage device. Further, network adapters or interfaces 412 such as TCP/IP adapter cards, wireless Wi-Fi interface cards, or 3G or 4G wireless interface cards, or other wired or wireless communication links are also included in computing devices.

In one example embodiment, the system 100 for automating the business process workflow may be stored in the tangible storage device 410 and may be downloaded from an external computer via a network (for example, the Internet, a local area network, or other, wide area network) and network adapter or interface 412.

Computing device 400 further includes device drivers 416 to interface with input and output devices. The input and output devices may include a computer display monitor 418, a keyboard 422, a keypad, a touch screen, a computer mouse 424, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A system for automating business process workflows, wherein the system comprises:
a user interface configured to receive natural language inputs corresponding to a business process from a user:
a large language model (LLM) based module configured to generate a generic automation structure for the business process in response to the received natural language inputs, wherein the automation structure comprises a plurality of atomic operations; and
an automation generation module configured to identify events and actions corresponding to each atomic operation of the automation structure using a pre-determined catalogue of available events and actions and to generate a deterministic workflow using the identified events and actions.

2. The system of claim 1, wherein the automation generation module is further configured to:
receive inputs for each of the plurality of atomic operations;
process the received input using the respective atomic operation and to generate a corresponding output; and
generate input for one or more subsequent atomic operations based upon the generated output of the previous atomic operations.

3. The system of claim 1, wherein the system is configured to:
present the inputs and/or output of each of the plurality of atomic operations to a user for review;
receive user inputs on the presented inputs and outputs; and
adjust and/or modify one or more of the inputs and the automation structure based upon the user inputs.

4. The system of claim 1, wherein the system is configured to facilitate migration of a plurality of automated business programs across one or more platforms using natural language.

5. The system of claim 1, wherein the automation generation module is configured to identify the events and actions corresponding to each atomic operation of the automation structure using a semantic search, a syntactic search, or combinations thereof.

6. The system of claim 5, wherein the automation generation module is configured to stitch together one or more of the events, actions and conditional checks to generate the deterministic workflow.

7. The system of claim 1, wherein the natural language comprises English language.

8. The system of claim 1, wherein the automation generation module is further configured to:
generate automation code using a rule engine;
present the automation code to a user for review and validation; and
modify the automation code based upon the user review to generate the modified automation code.

9. The system of claim 8, wherein the automation generation module is further configured to communicate with one or more databases to generate the automation code.

10. The system of claim 1, wherein the system comprises a cloud-based platform.

11. The system of claim 1, wherein the pre-determined catalogue is periodically updated with new events and actions.

12. A system for automating business process workflows, wherein the system comprises:
a memory storing one or more processor-executable routines; and
a processor communicatively coupled to the memory, the processor configured to execute the one or more processor-executable routines to:
receive natural language inputs corresponding to a business process;
generate a generic automation structure for a business process in response to the received natural language inputs, wherein the automation structure comprises a plurality of atomic operations; and
access a pre-determined catalogue of available events and identify events and/or actions corresponding to each atomic operation of the automation structure to generate a deterministic workflow corresponding to the business process; and
implement the deterministic workflow on a user platform.

13. The system of claim 12, wherein the processor is further configured to facilitate migration of a plurality of automated business programs across one or more user platforms using natural language.

14. The system of claim 12, wherein the processor further configured to adjust and/or modify one or more of the inputs and the automation structure based upon the user inputs.

15. The system of claim 12, wherein the processor further configured to update the pre-determined catalogue of available events and actions based on user feedback and/or system usage trends.

16. The system of claim 15, wherein the memory is configured to store the pre-determined catalogue of events and actions.

17. A method for automating business process workflows, wherein the method comprises:
receiving natural language inputs for a business process;
processing the inputs using large language model (LLM) to generate a generic automation structure, wherein the automation structure comprises a plurality of atomic operations corresponding to steps in the business process;
determining corresponding events and actions for each atomic operation via a pre-determined catalogue of available events and actions;
generating a deterministic workflow by integrating the determined events and actions into the generic automation structure;
providing the deterministic workflow for user review and/or modification; and
implementing the deterministic workflow to achieve a desired output.

18. The method of claim 17, further comprising:
receiving inputs for each of the plurality of atomic operations;
processing the received inputs using the respective atomic operation to generate a corresponding output; and
generating input for one or more subsequent atomic operations based on the generated output of the previous atomic operations.

19. The method of claim 17, further comprising:
presenting the inputs and/or outputs of each of the plurality of atomic operations to a user for review;
receiving user inputs regarding the presented inputs and outputs; and
adjusting and/or modifying one or more of the inputs and the automation structure based on the user inputs.

20. The method of claim 17, further comprising determining the events and actions corresponding to each atomic operation of the automation structure using a semantic search, a syntactic search, or combinations thereof.
